(19) United States
(12) Patent Application Publication
(10) Pub. No.: US 2014/0222760 A1
(43) Pub. Date: Aug. 7, 2014

(54) METHOD AND SYSTEM FOR RECONCILING REMOTE DATA

(71) Applicant: TRUSTEES OF BOSTON UNIVERSITY, Boston, MA (US)

(72) Inventors: Ari TRACHTENBERG, Newton, MA (US); Aryeh KONTOROVICH, Beer Sheva (IL)

(73) Assignee: TRUSTEES OF BOSTON UNIVERSITY, Boston, MA (US)

(21) Appl. No.: 14/172,264

(22) Filed: Feb. 4, 2014

Related U.S. Application Data
(60) Provisional application No. 61/760,642, filed on Feb. 4, 2013.

(51) Int. Cl. G06F 11/14

(52) U.S. Cl. CPC G06F 11/1448
USPC 707/641

(57) ABSTRACT

A method, system and non-transitory computer-readable storage medium for determining whether an unordered collection of overlapping substrings (called shingles) can be uniquely decoded into a consistent string. The method, system and medium are applicable to the fields of networking, data management, cryptography, genetic engineering and linguistics. Disclosed herein is a theoretic framework, an automata theoretic approach, and a time-optimal streaming algorithm for determining whether a string of characters over an alphabet can be uniquely decoded from its two (or more) character shingles. The present algorithm achieves an overall time complexity and space complexity. The method and system can be used to efficiently reconcile two data objects, files, strings or portions thereof.

### CROSS-REFERENCE TO RELATED APPLICATIONS

This application claims benefit under 35 U.S.C. §119(e) of U.S. Provisional Application No. 61/760,642 filed Feb. 4, 2013, which is hereby incorporated by reference in its entirety.

### STATEMENT REGARDING FEDERALLY SPONSORED RESEARCH

This invention was made with government support under grant no. CCF-0916892 awarded by the National Science Foundation. The government has certain rights in the invention.

### REFERENCE TO MICROFICHE APPENDIX

Not Applicable

### BACKGROUND

1. Technical Field of the Invention

The present invention is directed methods and systems for reconciling remote copies of a file with minimal communication, so as not to interfere with the main tasks of the underlying network or computer system. The specific approach involves breaking up files into collections of overlapping snippets, which can be reconciled using existing techniques.

2. Description of the Prior Art

There are a number of existing approaches to string reconciliation, although the hash-based rsync protocol appears to be the dominant approach in practice. Though rsync is very efficient in computation, the amount of data it must communicate is on the order of the size of the strings that are being reconciled, and this is not efficient for either bandwidth-constrained devices (such as smart phones) or very large files (as for cloud services).

Other approaches in the literature include more efficient hash-based approaches, such as those of Cormode et al. (ACM SODA 2000) and Orlitsky et al. (IEEE ISIT 2001), though the former needs to know, up front, how similar the strings are, and the latter could require significant computational resources. There are also approaches based on delta-compression, such as the work of Suel et al. (ICDE 2004).

### SUMMARY

Though the literature does have quite inefficient techniques for determining whether a string is uniquely decodable from its subsequences, the present innovation is as follows:
(1) online—requires only constant-time pre-processing;
(2) streaming—as soon as a non-uniquely-decodable prefix is read, the algorithm halts; and
(3) highly efficient—runs in linear time and requires constant memory.
The present technology can be used as an infrastructural element for a number of technologies.

For example, the present technology can be used in a string synchronization framework to enable very efficient synchronization of large files. More precisely, this innovation enables real-time synchronization with an amount of communication that can depend linearly on the number of edits between two files—thus, two petabyte files that differ in three edits (say, one letter is inserted, one is changed, and a third is deleted) could be synchronized with the one-way streaming of roughly three letters-worth of information (up to small but constant multiplicative overhead). This is extremely useful within the back-end of backup, cloud, or even content-delivery services, for example, that have to regularly synchronize this kind of data among different servers. Without the present innovation, there is no efficient means of implementing such a synchronization protocol right now. Also, in some embodiments, there is less prevalence of a linear-time string synchronization. For example, analysis shows linear-time string synchronization is generally true for very specific types of random strings, and some experimental data shows that linear-time string synchronization could be the case for practical strings.

The present technology might also be useful in some technologies for genome sequencing, for example, in which a collection of subsequences must be put together to reconstruct an original DNA sequence of an organism's genome. The present innovation could allow a sequencing tool to determine at what point it can stop because the subsequences found can be uniquely combined.

The present innovation should apply regardless of the lengths of the substrings or how much they overlap. It can also be extended to deal with a small number of subsequent repetitions, by systematically enumerating and checking all possibilities.

It is common for terabyte-size and petabyte-size databases to be regularly created, accessed and synchronized. The main bottleneck for such relatively large-scale databases is not storage space but algorithmic efficiency and, particularly in the case of synchronization, channel bandwidth.

The novel approach according to the present invention addresses both of these bottlenecks. At the heart of the present system and method is a technique known under various names (n-grams, shingling, hybridization and the like). The present inventors have advanced the state-of-the art by efficiently, dynamically maintaining an unambiguous decoding of the shingles on the fly. An algorithm according to the present invention is linear in sequence length and alphabet size, which is essentially the best one could hope for. The algorithm according to the present invention is applicable to any setting where long strings of data must by synchronized over a bandwidth-limited channel (such as data-sharing in the cloud).

A saving grace of the distributed data reconciliation problem is that it is often possible to exploit similarities in data to reduce communication complexity. As such, data that is common to two hosts need only be identified (rather than communicated), allowing collections of data to be mirrored consistently across many hosts without saturating the interconnections between the hosts. For an ad-hoc illustration of this phenomenon, consider two coauthors collaborating on a lengthy book. Though they may edit words or move sentences around, much of the text (including what is moved) stays the same. Thus, when the coauthors compare notes to collate the book, they need not send the entire draft back and forth, but merely to identify and communicate edits (e.g., “replace √(π/2) by e/2 in formula in (17)” or “move Section 4 to page 3”) that bring the texts into agreement.

The present invention systematizes this insight, placing it within a robust algorithmic framework and onto firm theoretical foundations. A first observation is that multisets, in which the order of elements is inconsequential, are fundamentally easier to reconcile than sequences, in which element order is informationally significant. Based on this observation, we reduce the sequence reconciliation problem to a multiset reconciliation problem by using a natural approach called shingling. When shingling, one obtains a multiset from a string by counting how many times various patterns (i.e., shingles) occur. Once two hosts agree on which of their shingles differ, each must reconstruct the other's sequence uniquely based on the differing shingles. In this scenario, the choice of shingles trades off with computational efficiency of the reconstruction, and the communication complexity of reconciling the shingles.

A solid understanding for one-dimensional sequences, such as strings, leads to sophisticated approaches for reconciling higher-dimensional data. For example, similar images might be similar up to transformation (e.g., rotation, resizing, or cropping), related graphs might share common subgraphs, or out-of-sync databases might share similar structure or hierarchical relationships.

A number of direct applications of the technology disclosed in “Unique decodability for string reconciliation” are described herein including but not limited to the following: mobile devices, backup systems, cloud computing systems, content delivery systems and gene sequencing systems. Although these specific devices and systems are described, the present invention should in no way be limited to these devices and systems. The present system and method can be applied to any situation where it is desired to decode and reconcile two strings of data.

Mobile devices have to maintain synchronicity of their data with servers, home/work desktop machines, and other mobile devices. Their memory and CPU strength is often limited but, more importantly, their communication rate is quite constrained by available bandwidth and users are charged significantly for its use.

According to the system and method of the present invention, mobile devices are provided with a means to synchronize large data files or folders with little communication. This could be used to maintain identical versions of calendars, to-do lists, e-mail folders, word processing documents and the like on a number of mobile devices and/or servers to which they connect.

In a typical implementation, a mobile host would request a synchronization with another host (possibly using a standardized protocol, such as the Open Mobile Alliance Data Synchronization protocol); each host would then shingle their document into a large collection of substrings, which would be synchronized using an existing set-reconciliation algorithm; each host would then put together the other host's shingles into a string so that both hosts now know the other host's string.

The algorithm according to the present invention comes into play in determining what kind of shingling would enable the entire synchronization process.

The same approach above can be utilized to efficiently maintain backups, or to more quickly recover a corrupted disk from an existing backup. In the latter case, suppose that a backup version of a disk exists, but that the disk itself is corrupted. Existing approaches rely on modification of data stored on the disk to determine what has been corrupted, but if this modification data itself is corrupted, then a very time-consuming full-disk transfer must be made from the backup device to the corrupted disk (or a brand new disk).

With the technology of the present invention, it is possible to determine the differences between the corrupted disk and the backup disk with little communication, essentially pinpointing and fixing the data that is corrupted. If a new disk is needed, data can be salvaged, as much as possible, from the corrupted disk and then synchronized with the backup to quickly bring a user up and running.

Cloud computing services often require that their data be maintained in duplicate on several machines, both for robustness and for accessibility. Since disk corruptions are quite common in large-scale systems, it is often necessary to restore some of the duplicates upon corruption, and this can consume significant in-cloud network resources that could otherwise be utilized for customers. According to the present invention, cloud providers utilize the present system and method to efficiently correct corruptions (utilizing the approaches described herein and in Appendices A and B).

When content must be delivered to many recipients (e.g., video-on-demand to cable users), a common model is for the data to be copied to intermediaries, who copy it further to other intermediaries in parallel, until the video is received at the users. According to the present invention, content providers can stream just some of the content (say, part of the video) to different intermediaries, and then have the intermediaries synchronize their data to “fill in the gaps” (i.e., the content that they did not receive). This distributes the content delivery, potentially permitting higher throughput to the end users.

Certain gene sequencing systems (e.g., shotgun sequencing) produce short reads of contiguous DNA fragments, which must be then algorithmically reconstructed into the overall sequence. The present invention can be used to efficiently determine, for example, when to stop producing reads because the overall sequence can be uniquely determined from the existing fragments.

### BRIEF DESCRIPTION OF THE FIGURES

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 shows a system in accordance with one embodiment of the invention.

### DETAILED DESCRIPTION OF PREFERRED EMBODIMENTS

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

The present invention is directed to a method, system and non-transitory computer-readable storage medium for reconciling remotely located data. In accordance with the embodiments of the invention, a method for efficiently decoding a string of data from a shingle or set of shingles can be used. Examples of algorithms for efficiently coding and decoding data according to some of the embodiments of the invention are disclosed in A. Kontorovich and A. Trachtenberg, “Efficiently decoding strings from their shingles,” attached hereto as Appendix A and in A. Kontorovich and A. Trachtenberg, “Unique decodability for string reconciliation” as Appendix B, both of which are incorporated herein by reference in their entirety.

The present invention relates generally to the field of data integrity and specifically, for example, to mobile devices, backup systems, cloud computing systems, content delivery systems, gene sequencing systems, sequencing DNA from relatively short reads, reconstruction of protein sequences from K-peptides and the like. Any two strings of data could benefit from the present decoding and reconciliation method and system. In its practical application, the invention is directed to an algorithm for efficiently determining whether a given collection of substrings can be uniquely combined into a string. Previous methods used a deterministic finite-state automaton (DFA) or a non-deterministic finite-state automaton (NFA) to make this determination.

In some embodiments, there can be a first step of splitting first and second strings into first and second sets of shingles (or substrings); a second step of reconciling the sets; a third step of setting a multiset of shingles that have been identified thus far in the process; a fourth step of merging shingles by computing the non-overlapping concatenation for the two shingles; a fifth step of exchanging indices of merged shingles (based on whether any set is not uniquely decodable); and a sixth step of using the resulting collection of uniquely decodable shingles (such as that shown in the FIG. 4 de Bruijn graph) to reconcile the first and second strings.

Whenever copies of a file are shared in various locations it is necessary to make sure that changes in one copy are propagated to all the others. This is true for documents that may be edited from various locations, cloud services that maintain multiple copies of a file for accessibility or reliability, and content delivery networks in which different users receive similar but incomplete content and can communicate with each other to fill in gaps.

The present invention addresses the problem of efficiently reconciling different copies of a file that are stored at remote locations, where efficiency is measured in terms of amount of communication. This problem is evident in applications such as cloud computing, content delivery networks, and possibly to gene sequencing. For example, in the cloud computing domain, a document may be replicated internally at various servers and changes to a replica must be efficiently propagated throughout the cloud.

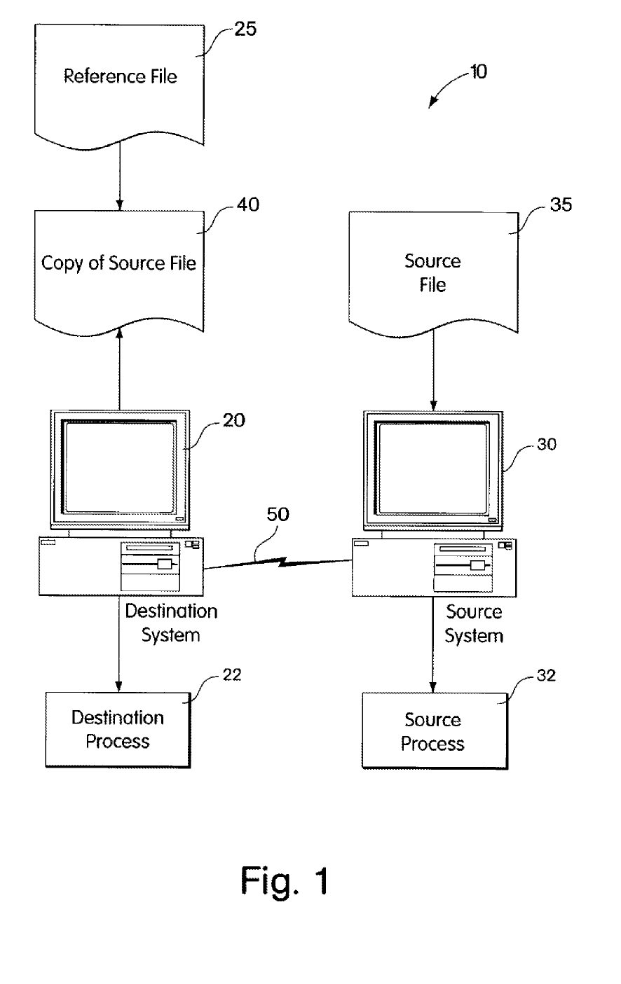

FIG. 1 shows a system 10 in accordance with the preferred embodiment of the invention. The system 10 includes a destination system 20 and source system 30. For purposes of illustration, the destination process can be performed by the destination system 20 and the source process can be performed by the source system 30. The destination system 20 includes memory that contains a stored copy of a file, herein referred to as a reference file 25 and a destination location 20 for storing a copy of the source file 40 to be reconstructed from the reference file 25. The source system 30 includes a source file 35 which is a revised copy of the reference file 25 (e.g., the source file 35 can be produced by making one or more changes to the reference file 25). In one embodiment, the destination process is embodied in software 22, stored in memory of the destination system 20 and executed by the central processing unit (CPU) (not shown) of the destination system 20 and the source process is embodied in software 32, stored in memory of the source system 30 and executed by the CPU (not shown) of the source system 30.

A communications link 50 interconnects destination system 20 and source system 30 to enable data to be transferred bidirectionally between the destination system 20 and the source system 30. The communications link 50 can be any means by which two systems can transfer data such as a wired connection, e.g., a serial interface cable, a parallel interface cable, or a wired network connection; or a wireless connection, e.g., infrared, radio frequency or other type of signal communication techniques or a combination of both. In the preferred embodiment, the destination system 20 and the source system 30 include modems (not shown) and are interconnected via a public switched telephone network (PSTN). In addition, the communications link 50 is considered to provide an error correcting link between the destination system 20 and source system 30 and thus the source and destination processes can assume that data transmitted is received without errors.

In accordance with some embodiments of the present invention, the source system 30 generates a set of shingles from the source file 35 and the destination system 20 generates a set of shingles from the reference file 25. Next, the sets of shingles are reconciled. In one embodiment of this step, one or more shingles, tokens (e.g., indices) representative of one or more shingles and/or other messages are transmitted between the source system 30 and the destination system 20 in order for the systems to determine the differences between the sets of shingles. At the end of the reconciliation process, the set of shingles at the source system 30 is the same as the set of shingles at the destination system 20. Each system includes a common set of shingles.

Next, the source system 30 generates a set of shingles that uniquely decodes into the source file 35 and the destination system 20 generates a set of shingles that uniquely decodes into the reference file 35. An algorithm for generating the uniquely decodable set of shingles is described in Section IV of Appendix A. In accordance with one embodiment of the invention, this can include merging shingles within the set at each system in order produce uniquely decodable set of shingles at each system. Each system also retains a copy of the common set of shingles. Because the source file 35 and the reference file 25 are different, this will result in a different set of shingles at each location.

Next, the source system 30 sends the tokens or indices of the merged shingles to the destination system 20. Optionally, the destination system sends the indices of the merged shingles to the source system 30. (If, for example, a source file is recreated at a destination, there is no need for the destination to send merged shingle data back to the source.) At the destination, the destination system 20 uses the tokens or indices of the merged shingles received from the source system 20 to construct the uniquely decodable set of shingles for the source file. This can be used to reconstruct the source file.

Next, (uniquely) decode, at the destination system 30, the set of shingles for the source file 35 and replace the reference file 25 with the reconstructed source file 25.

It is noted that the application of the present method and system to a “file” as such term is used herein is not intended to be limiting. In the above description, it is to be understood that a “file” can be any string of data, one or more sub-sections of a file, streams of data and the like.

Optionally, instead of using the decode process of the set of shingles, only those shingles that have changes or are different can be selected and used to essentially modify portions of an old file and create a source file. This is particularly useful if there are only two parties synchronizing data, and if the parties maintain proper version histories. At each synchronization, modifications made since the last synchronization can be exchanged.

With very large files, transmitting shingles or tokens saves bandwidth. One-way synchronization can be done without feedback (this is useful for certain cryptographic primitives, like biometric authentication, for example). The underlying testing for unique decoding can be applied, for example, to gene sequencing.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

Example 1—Appendix A provides an example of how to efficiently decode strings from their shingles.

Example 2—Appendix B provides an example of how to use unique decodability for string reconciliation.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

1. A computer implemented method for reconciling a first data string and second data string, comprising:
on a device having one or more processors and a memory storing one or more programs for execution by the one or more processors, the one or more programs including instructions for:
generating a first set of shingles from the first data string and a second set of shingles from the second data string;
reconciling the first set of shingles and the second set of shingles;
generating a first set of shingles that is uniquely decodable to the first data string from the first set of shingles and generating a second set of shingles that is uniquely decodable to the second data string from the second set of shingles, wherein generating each uniquely decodable set of set of shingles includes merging two or more shingles in a set;
exchanging indices of merged shingles; and
using the uniquely decodable sets of shingles to reconcile the first data string and the second data string.

2. The method of claim 1, further comprising instructions for:
setting a multiset of shingles that have been identified thus far; and
merging shingles by computing the non-overlapping concatenation for the two shingles.

3. A computer system for reconciling a first data string and second data string, comprising:
one or more processors; and
memory to store:
one or more programs, the one or more programs comprising instructions for:
generating a first set of shingles from the first data string and a second set of shingles from the second data string;
reconciling the first set of shingles and the second set of shingles;
generating a first set of shingles that is uniquely decodable to the first data string from the first set of shingles and generating a second set of shingles that is uniquely decodable to the second data string from the second set of shingles, wherein generating each uniquely decodable set of set of shingles includes merging two or more shingles in a set;
exchanging indices of merged shingles; and
using the uniquely decodable sets of shingles to reconcile the first data string and the second data string.

4. The system of claim 3, further comprising instructions for:
setting a multiset of shingles that have been identified thus far; and
merging shingles by computing the non-overlapping concatenation for the two shingles.

5. A non-transitory computer-readable storage medium storing one or more programs configured to be executed by one or more processing units at a computer comprising instructions for:
generating a first set of shingles from the first data string and a second set of shingles from the second data string;
reconciling the first set of shingles and the second set of shingles;
generating a first set of shingles that is uniquely decodable to the first data string from the first set of shingles and generating a second set of shingles that is uniquely decodable to the second data string from the second set of shingles, wherein generating each uniquely decodable set of set of shingles includes merging two or more shingles in a set;
exchanging indices of merged shingles; and
using the uniquely decodable sets of shingles to reconcile the first data string and the second data string.

6. The method of claim 6, further comprising instructions for:
setting a multiset of shingles that have been identified thus far; and
merging shingles by computing the non-overlapping concatenation for the two shingles.

7. A computer system for reconciling a first data string and second data string, comprising:
one or more processors; and
memory to store:
means for generating a first set of shingles from the first data string and a second set of shingles from the second data string;
means for reconciling the first set of shingles and the second set of shingles;
means for generating a first set of shingles that is uniquely decodable to the first data string from the first set of shingles and generating a second set of shingles that is uniquely decodable to the second data string from the second set of shingles, wherein generating each uniquely decodable set of set of shingles includes merging two or more shingles in a set;
means for exchanging indices of merged shingles; and
means for using the uniquely decodable sets of shingles to reconcile the first data string and the second data string.

8. The method of claim 7, further comprising:
means for setting a multiset of shingles that have been identified thus far; and
means for merging shingles by computing the non-overlapping concatenation for the two shingles.
